(19) United States
(12) Patent Application Publication
(10) Pub. No.: US 2019/0159408 A1
(43) Pub. Date: May 30, 2019

(54) PLANT PROTECTION DEVICE

(71) Applicant: Ashley Fletcher, San Diego, CA (US)

(72) Inventor: Ashley Fletcher, San Diego, CA (US)

(21) Appl. No.: 16/201,795

(22) Filed: Nov. 27, 2018

Related U.S. Application Data
(60) Provisional application No. 62/591,362, filed on Nov. 28, 2017.

(51) Int. Cl. A01G 13/04; A01G 13/02

(52) U.S. Cl. CPC A01G 13/04; A01G 2013/006; A01G 13/0243; A01G 13/0237

(57) ABSTRACT

The present disclosure relates to a plant protection device having two substantially hemispherical portions, two rim portions, each attached to a perimeter of one of the substantially hemispherical, two connectors capable of attaching the two rim portions and the two substantially hemispherical portions to each other in a substantially a spherical shape, a first opening in one of the two substantially hemispherical portions, and a second opening in one of the two substantially hemispherical portions. The first opening and the second opening may be positioned to accommodate a first and a second portion of branch or plant part, respectively.

### BACKGROUND

### Field

Embodiments of the disclosure are generally related to a device for protecting plants having a rigid mesh that allows sunlight to reach the plant that is inside the device. Embodiments are capable of being used for many different plants including fruit that is on branches or vines as well as young seedlings.

### Description of the Related Art

Fruits, vegetables, flowers, and other plants or plant components are vulnerable to animals, bugs, pests, parasites, and other predators. Many plants are especially vulnerable while they are younger in their life-cycles. Previous inventions have attempted to protect plants by providing an opaque barrier around the plants. However, many plants require sunlight. Thus, it is undesirable to protect plants with an opaque barrier that blocks or restricts sunlight to the plants it protects. Thus, there remains a need for plant protection devices that provide for light penetration.

### SUMMARY OF CERTAIN INVENTIVE ASPECTS

According to one aspect, a plant protection device is provided. The plant protection device may include, for example, two substantially hemispherical rigid meshes; two rim portions, each attached to substantially the entire length of a perimeter of one of the substantially hemispherical rigid meshes; two connectors capable of attaching the two rim portions and the two substantially hemispherical rigid meshes to each other in a substantially spherical shape; a first opening in one of the two substantially hemispherical rigid meshes; and a second opening in one of the two substantially hemispherical rigid meshes. In some embodiments, the first opening and the second opening are positioned to accommodate a first and a second portion of branch or plant part, respectively.

According to one aspect, a seedling protection device is provided. The seedling protection device may include, for example, a substantially hemispherical rigid mesh; a rim portion attached to substantially the entire length of a perimeter of the substantially hemispherical rigid mesh; and two eyelets attached to the rim portion.

According to one aspect, a seedling protection system is provided. The seedling protection system may include, for example, a substantially hemispherical rigid mesh; a rim portion attached to substantially the entire length of a perimeter of the substantially hemispherical rigid mesh; an eyelet attached to the rim portion; and a stake penetrating through the eyelet to anchor the rim portion in proximity to a seedling.

According to one aspect, a plant protection device is provided. The plant protection device may include, for example, two hemispheres; a first hole pattern embedded on a first hemisphere; a second hole pattern embedded on a second hemisphere; a rim portion attached to each of the two hemispheres; a hinge attached to the rim portion; two connectors capable of attaching the two rim portions and the two hemispheres to each other to create a substantially spherical shape. In some embodiments, a first opening is included in one of the two hemispheres. In some embodiments a second opening is included in one of the two hemispheres. In some embodiments, the first opening and the second opening are positioned to accommodate a first and a second portion of branch or plant part, respectively.

According to one aspect, a plant protection system is provided. The plant protection system may include, for example, two hemispheres, where each hemisphere has a curved section and a top section. In some embodiments, a first hole pattern is embedded on a first top section and a second hole pattern is embedded on the second top section. In some embodiments, a rim portion is attached to each of the two hemispheres. In some embodiments, a hinge attaches a rim on a first hemisphere to a rim on a second hemisphere. In some embodiments, the first rim includes a first connector and the second rim includes a second connecter, the two connectors capable of attaching the two rim portions and the two hemispheres to each other to create a substantially spherical shape. In some embodiments, the, a first opening is included in one of the two hemispheres. In some embodiments a second opening is included in one of the two hemispheres. In some embodiments, the first opening and the second opening are positioned to accommodate a first and a second portion of branch or plant part, respectively.

In another aspect, a plant protection device is provided. The plant protection device may include, for example, a first substantially half spherical hemisphere having a first rim portion positioned around a perimeter portion thereof, the first substantially half spherical hemisphere having a substantially hollow interior and two first branch openings substantially opposite each other on the first rim portion, a second substantially half spherical hemisphere having a second rim portion position around a perimeter portion thereof, the second substantially half spherical hemisphere having a substantially hollow interior, a first connector on the first rim portion, a second connector on the second rim portion configured to mate with the first connector, and a hinge portion connecting the first rim portion to the second rim portion, the hinge portion having an open configuration and a closed configuration.

In some embodiments, when the hinge portion is in a closed configuration the first connector contacts the second connector and the first substantially half spherical hemisphere and the second substantially half spherical hemisphere together form a substantially spherical shape. In some embodiments, the second substantially half spherical hemisphere comprises two second branch openings positioned substantially opposite each other on the second rim portion. In some embodiments, the first substantially half spherical hemisphere includes a plurality of holes extending therethrough. In some embodiments, the second substantially half spherical hemisphere includes a plurality of holes extending therethrough. In some embodiments, the first substantially half spherical hemisphere has a top section that is substantially flat, the top section including a plurality of holes extending therethrough. In some embodiments, the second substantially half spherical hemisphere has a bottom section that is substantially flat, the bottom section including a plurality of holes extending therethrough.

### BRIEF DESCRIPTION OF THE DRAWINGS

FIG. 1 is a front perspective view of an embodiment of a plant protection device engaged around a branch with fruit.

FIG. 2 is a front perspective view of an embodiment of a seedling protection system.

FIG. 3 is a front-side view of the plant protection device of FIG. 1.

FIG. 4 is a right-side view of the plant protection device of FIG. 1.

FIG. 5 is a top-down view of the plant protection device of FIG. 1.

FIG. 6 is an exploded view of one hemisphere of the plant protection device according to one embodiment.

FIG. 7a is a front perspective view of an embodiment of a plant protection device in a closed configuration.

FIG. 7b is a front perspective view of an open plant protection device of FIG. 7a.

FIG. 8a is a front perspective view of an embodiment of a plant protection device in a closed configuration.

FIG. 8b is a front perspective view of an open plant protection device of FIG. 8a.

### DETAILED DESCRIPTION OF CERTAIN INVENTIVE EMBODIMENTS

Any feature or combination of features described herein are included within the scope of the present disclosure provided that the features included in any such combination are not mutually inconsistent as will be apparent from the context, this description, and the knowledge of one skilled in the art. In addition, any feature or combination of features may be specifically excluded from any embodiment of the present disclosure. For purposes of summarizing the present disclosure, certain aspects, advantages, and novel features of the present disclosure are described herein. Of course, not necessarily all such aspects, advantages, or features will be present in any particular embodiment of the present disclosure.

Embodiments presented herein are by way of example and not by way of limitation. The intent of the following detailed description, although discussing exemplary embodiments, is to be construed to cover all modifications, alternatives, and equivalents of the embodiments as may fall within the spirit and scope of the disclosure.

Embodiments of the present disclosure relate to a plant protection device that can surround or cover plants or portions of plants to provide protection. These embodiments are capable of providing protection from many predators. These predators includes common garden predators like squirrels, birds, snails, rodents, insects, etc. The plant protection device can provide this protection while still allowing the plants access to sunlight that they may need to grow or continue growing. The plant protection device can allow the plants to have access to sunlight by utilizing a mesh that does not completely occlude the sunlight. In some embodiments, the mesh is rigid. In some embodiments, the mesh is wire. In some embodiments, the mesh is a rigid wire mesh. The plant protection device can provide convenient protection through being easily attachable to many different plants of many different sizes. The plant protection device can be used on seedlings that have just sprouted. Seedlings could then be watered through the rigid wire mesh. Additionally, the plant protection device can be used to protect larger fruit and/or fully formed fruit.

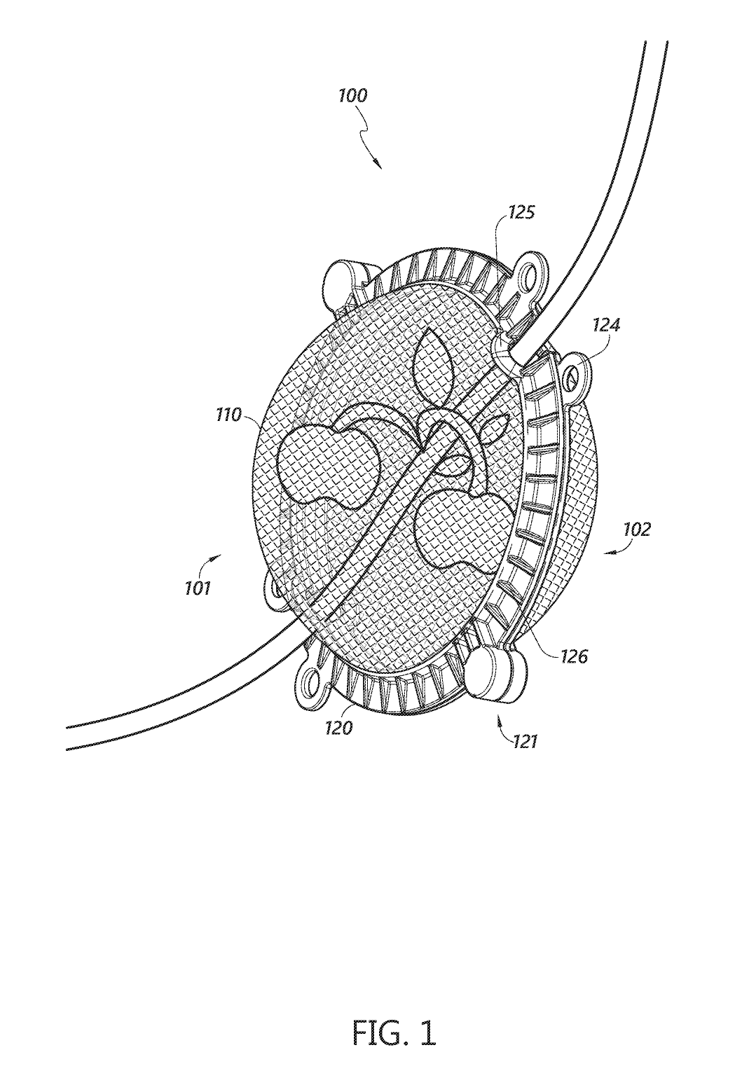

FIG. 1 shows a front perspective view of an embodiment of a plant protection device engaged around a branch with fruit. The plant protection device 100 includes a substantially hemispherical rigid mesh 110. The substantially hemispherical rigid mesh 110 can be capable of protecting plants and seedlings from predators or other animals or environmental forces that could damage the plants or seedlings. The substantially hemispherical rigid mesh 110 can provide protection while still allowing the plants to be exposed to light. The substantially hemispherical rigid mesh 110 can provide the plants with light exposure by being composed of a mesh which does not occlude a substantial portion of sunlight from reaching the plants like other protection devices might. In certain embodiments, the substantially hemispherical rigid mesh 110 may include or be formed of a wire mesh. In certain embodiments, the substantially hemispherical rigid mesh 110 can be made from thread, fibers, or some other type of material capable of being interlaced.

In certain embodiments, the substantially hemispherical rigid mesh 110 includes a fine material or a mesh of material with small diameter. In certain embodiments, the substantially hemispherical rigid mesh 110 will allow a substantial amount of light and ambient atmosphere to reach the plant inside of the plant protection device 100. In certain embodiments, the substantially hemispherical rigid mesh 110 will not occlude a substantial amount of the light that would otherwise be passing through the substantially hemispherical rigid mesh 110 if it were not there. In this way, the plant protection device 100 can be used to protect plants within it while at the same time allowing light to reach those plants. In certain embodiments, the substantially hemispherical rigid mesh 110 can be composed of metals including but not limited to stainless or other steel, brass, aluminum, or some other metal or alloy. In certain embodiments, the substantially hemispherical rigid mesh 110 can be made from a plastic or polymer. In some embodiments, the substantially hemispherical rigid mesh 110 can be made by extruding or by 3D-printing. In certain embodiments, the substantially hemispherical rigid mesh 110 will have a modulus of elasticity of between 160 and 220 GPa. In certain embodiments, the substantially hemispherical rigid mesh 110 will have a modulus of elasticity of about 193 GPa. In certain embodiments, the substantially hemispherical rigid mesh 110 includes a wire of between about 20 gauge and about 40 gauge. In certain embodiments, the substantially hemispherical rigid mesh 110 includes a wire of about 30 gauge. In certain embodiments, the edge of the substantially hemispherical rigid mesh 110 includes a diameter of between 1 and 24 inches, for example, 1, 2, 3, 4, 5, 6, 7, 8, 9, 10, 11, 12, 13, 14, 15, 16, 17, 18, 19, 20, 21, 22, 23, or 24 inches or any value in between. In certain embodiments, the edge of the substantially hemispherical rigid mesh 110 includes a diameter of about 5.5 inches. In certain embodiments, the edge of the substantially hemispherical rigid mesh 110 can have a perimeter of between about 5 inches and 40 inches, for example, 5, 6, 7, 8, 9, 10, 11, 12, 13, 14, 15, 16, 16.5, 17, 17.5, 18, and 18.5, 19, 20, 21, 22, 23, 24, 24, 25, 26, 27, 28, 29, 30, 31, 32, 33, 34, 35, 36, 37, 38, 39, or 40 inches or any value in between. In certain embodiments, the edge of the substantially hemispherical rigid mesh 110 includes a perimeter of about 17.3 inches. In certain embodiments, the edge of the substantially hemispherical rigid mesh 110 includes a height, or distance from the edge to the apex of between 1.0 and 12.0 inches, for example, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3, 4, 5, 6, 7, 8, 9, 10, 11, or 12 inches or any value in between. In certain embodiments, the edge of the substantially hemispherical rigid mesh 110 includes a height, of about 2.1 inches.

In certain embodiments, the fruit protection device 100 includes two hemispherical pieces, a first hemisphere 101 and a second hemisphere 102. In certain embodiments, the first hemisphere 101 and second hemisphere 102 can join together to form the substantially spherical plant protection device 100. In certain embodiments with two substantially hemispherical rigid meshes 110, the plant protection device 100 can be assembled around a piece of fruit that is still attached to a vine, branch, or some other portion of the plant from which it is growing. In this way, the plant protection device 100 can protect a plant from predators while the plant is still growing in situations where other plant protection devices would not be able to protect the plant as effectively.

In certain embodiments, the plant protection device 100 can also include a rim portion 120. In certain embodiments, the rim portion 120 can be disposed on the edge of the substantially hemispherical rigid mesh 110. In certain embodiments, the rim portion 120 can define the circular boundary that is the edge of a hemisphere 101, 102. The rim portion 120 can be attached to substantially the entire length of the perimeter of the circular boundary that is the edge of a hemisphere 101, 102. In certain embodiments, the rim portion 120 is capable of protecting the edge of the substantially hemispherical rigid mesh 110 in a way that prevents the mesh from coming apart of unweaving. In certain embodiments, the rim portion 120 of two hemispheres 101, 102 will be adjacent or proximate to each other when the device 100 is assembled as a sphere. In certain embodiments, the rim portions 120 of two hemispheres 101, 102 will be substantially in contact with each other when the device 100 is assembled as a sphere. In certain embodiments, the rim portions 120 will form a substantially sealed interface. In certain embodiments where the rim portions 120 form a substantially sealed interface, the substantially sealed interface can prevent bugs or insects or birds or other small animals from entering the device 100 or prying apart the device 100.

In some embodiments, the rim portion 120 is made from a substantially rigid material. The substantially rigid material might include, for example, HDPE or other plastics, steel, aluminum, or other metals, metal alloys, polymers, composite materials, or some combination thereof, or some other material. In certain embodiments, the rim portion 120 can be made by 3D printing. The rim portion 120 can be made from the same piece of material as the substantially hemispherical rigid mesh 110 or can be a separate component. In certain embodiments, the rim portion 120 includes flanges or ribs 126 arranged perpendicularly with respect to a face of the rim portion 120 and spaced around the circumference of the rim portion 120. In certain embodiments where the rim portion 120 includes ribs 126, the ribs 126 can provide additional strength, robustness, rigidity, and/or stability to the device. Additional strength, robustness, rigidity, and/or stability can make the device 100 more resistant to being broken by users or animals. In certain embodiments, the rim portion 120 includes a bug or insect repellent. In certain embodiments, the rim portion 120 can emit a sound, smell, or other signal that may repel bugs or insects or birds or other small animals. In certain embodiments, the rim portion 120 includes an outer diameter of between 5.5 to 7 inches. For example, the outer diameter might be 5, 6, 7, 8, 9, 10, 11, 12, 13, 14, 15, 16, 16.5, 17, 17.5, 18, and 18.5, 19, 20, 21, 22, 23, 24, 24, 25, 26, 27, 28, 29, 30, 31, 32, 33, 34, 35, 36, 37, 38, 39, 40 or 41 inches or any value in between. In certain embodiments, the rim portion 120 includes an outer diameter of about 6.15 inches. In certain embodiments, the rim portion 120 includes an inner diameter of between 5 and 6 inches. For example, the inner diameter might be 5, 6, 7, 8, 9, 10, 11, 12, 13, 14, 15, 16, 16.5, 17, 17.5, 18, and 18.5, 19, 20, 21, 22, 23, 24, 24, 25, 26, 27, 28, 29, 30, 31, 32, 33, 34, 35, 36, 37, 38, 39, or 40 inches or any value in between. In certain embodiments, the rim portion 120 includes an inner diameter of about 5.5 inches. In certain embodiments, the ribs 126 includes a width of about 0.08 inches and a height of about 0.26 inches. In certain embodiments, the rim portion 120 includes between 35 to 45 ribs 126.

In certain embodiments, the plant protection device 100 includes a connector 121. In certain embodiments, the connector 121 includes a magnet 122 or a disk of ferromagnetic material 123. In certain embodiments, one or more connectors 121 can be disposed on the rim portion 120 of the plant protection device 100. In certain embodiments, the first and second hemispheres 101, 102 each include two connectors 121. In certain embodiments, the connectors 121 on the first and/or second hemispheres 101, 102 each include one magnet 122 and one disk of ferromagnetic material 123. The magnet 122 and disk of ferromagnetic material 123 can be used to substantially connect two connectors 121. A connector 121 including a magnet 122 on one hemisphere 101, 102 can be used to connect to a connector 121 including a disk of ferromagnetic material 123 on the other hemisphere 101, 102. Connectors 121 including magnets 122 and disks of ferromagnetic material 123 can be used to create a connection between two hemispheres 101, 102 such that the hemispheres 101, 102 are firmly connect yet are capable of being disconnected by pulling the hemispheres 101, 102 apart by hand. In certain embodiments, the second hemisphere 102 includes a different number of connectors 121 than the first hemisphere 101. In certain embodiments, the first and second hemispheres 101, 102 each include one or less connectors 121. In certain embodiments, the first and second hemispheres 101, 102 each includes more than two connectors 121 each. In certain embodiments, connectors 121 can be formed of, at least partially of, the same material as the rim portion 120. In certain embodiments, at least a portion of the connectors 121 can be formed as part of the same piece of material as the rim portion 120. A person of skill in the art will appreciate that although connectors 121 using magnets 122 are described above; there are many different types of connectors 121 that can be used to join two hemispheres 101, 102 to each other including but not limited to, grommets, Velcro, ties, locking pins, or other types of mechanical, magnetic, or electric fasteners. In certain embodiments where the connectors 124 are attached to the rim portion 120, the connectors 121 can extend out away from the rim portion 120 to a distance of about 0.55 inches.

In certain embodiments, the plant protection device 100 includes an eyelet 124. In certain embodiments, the plant protection device 100 includes two or more eyelets 124. In certain embodiments, the first and/or second hemispheres 101, 102 includes one or more eyelets 124. In certain embodiments, the eyelets 124 can be disposed on the rim portion 120 of the first and/or second hemisphere 101, 102. An eyelet 124 includes a circular component or ring. In certain embodiments, eyelets 124 includes tabs. The eyelets 124 can be arranged on the rim portion 120 such that the openings of the eyelets 124 are oriented in substantially the same direction as the opening of the first and/or second hemisphere 101, 102. The eyelets 124 can facilitate the attachment of various things to the plant protection device 100 or the first and/or second hemisphere 101, 102 of the plant protection device 100. The eyelets 124 can facilitate the connection between multiple plant protection devices 100 or hemispheres 101, 102. In certain embodiments, the eyelets 124 serve as attachment points for wires, strings, or other supporting components. These wires, strings, or other supporting components can also be attached to other branches or portions of a tree, plant, or nearby structure. In certain embodiments, these wires, strings, or other supporting components can be used to support at least a portion of the weight of the plant protection device 100. In certain embodiments, eyelets 124 can be formed of at least partially of the same material as the rim portion 120. In certain embodiments, at least a portion of the eyelets 124 can be molded as part of the same piece of material as the rim portion 120. In certain embodiments, where the eyelets 124 are attached to the rim portion 120, the eyelets 124 can extend out away from the rim portion 120 to a distance of about 0.55 inches. In certain embodiments, the eyelets 124 will include a hole with a diameter of about 0.34 inches. A person of skill in the art will appreciate that the eyelets can be shaped or oriented in a variety of different ways to accommodate different types of connectors and connections.

In certain embodiments, the plant protection device 100 includes a branch opening 125. In certain embodiments, the first and/or second hemispheres 101, 102 includes one or more branch openings 125. In certain embodiments, the first and/or second hemispheres 101, 102 include two or more branch openings 125 each. The branch opening 125 can allow a branch, vine, or other plant structure to pass through the plant protection device 100. In certain embodiments, a branch opening 125 will include a semicircular opening in the rim portion 120 and the substantially hemispherical rigid mesh 110. In certain embodiments, one or more hemispheres 101, 102 may have no branch openings 125. In certain embodiments, one of the hemispheres 101, 102 may have one or more branch openings 125 while the other hemisphere 101, 102 has no branch openings 125. In certain embodiments, the branch openings 125 may each include a full circular opening.

In certain embodiments, a person can use the plant protection device 100 to protect fruit that is growing on a branch. One can take two hemispheres 101, 102 of a plant protection device 100 and place them together such that they form a substantially spherical plant protection device 100 surrounding the fruit. Additionally, one can align the connectors 121 on each hemisphere 101, 102 such that the connectors 121 on one hemisphere 101, 102 are facing and/or proximal to the connectors 121 on the other hemisphere 101, 102. This alignment can either be done while placing the two hemispheres 101, 102 together or by rotating the hemispheres 101, 102 after they have been combined. Further, the branch openings 125 can be aligned such that any branch or vine that the fruit is growing on will pass through branch openings 125. In certain embodiments, the branch openings 125 on one hemisphere 101, 102 will align with the branch openings 125 of the other hemisphere 101, 102 when the connectors 121 of each hemisphere 101, 102 are aligned. Thus, the method for engaging a plant protection device 100 around a piece of fruit on a branch includes the steps of aligning the connectors 121, branch openings 125, and branches/vines in addition to placing the hemispheres 101, 102 together with their openings mating against each other or proximal to each other. In certain situations and/or embodiments, the method for engaging a plant protection device 100 around a piece of fruit includes connecting one end of strings, wires, or other supporting components to the eyelets 124 and then connecting the other ends to branches or other parts of a plant or nearby structure.

The plant protection device 100 can be used to protect a variety of plants and/or their fruits including a variety of apples, tomatoes, grapes, pears, peaches, oranges, bananas, strawberries, blueberries, blackberries, boysenberries, raspberries, other berries, cherries, figs, currants, starfruit, dragon fruit, passion fruit, jackfruit, persimmons, melons, lemons, limes, nectarines, plums, melons, avocados, nuts, chili peppers, green peppers, red peppers, orange peppers, jalapeno peppers, kale, chard, spinach, okra, flowers, hops, kiwi, mushrooms, and many other types of plants and fungi.

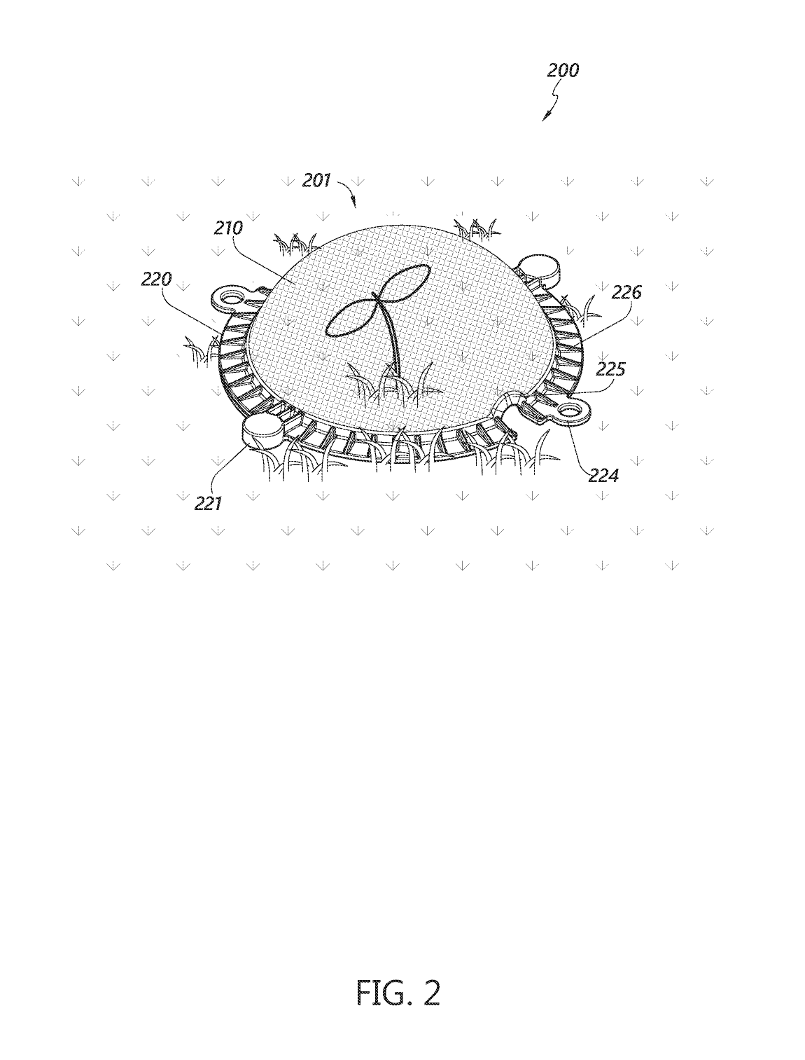

FIG. 2 shows a front perspective view of an embodiment of a seedling protection system 200. The seedling protection system 200 of FIG. 2 includes a seedling protection device 201. According to some embodiments, the seedling protection device 201 includes a singular hemisphere. In certain embodiments, a seedling protection device 201 can be used to cover a seedling, sprouting plant, or other relatively small plant. In certain embodiments, the seedling protection device 201 includes a rim portion 220. In certain embodiments, the rim portion 220 includes a flange that extends away from the substantially hemispherical rigid mesh 210 in a direction parallel to the opening of the seedling protection device 201. In certain embodiments, the flange may help prevent bugs, insects, birds, snails, caterpillars, or other small animals from entering the seedling protection device 201. In certain embodiments, the rim portion 220 includes ribs 226 arranged perpendicularly with respect to a face of the rim portion 220 and spaced around the circumference of the rim portion 220. In certain embodiments where the rim portion 220 includes ribs 226, the ribs 226 can provide additional strength, robustness, rigidity, and/or stability to the device. Additional strength, robustness, rigidity, and/or stability can make the device 201 more resistant to being broken by users or animals. In certain embodiments, the rim portion 220 includes a bug or insect repellent. In certain embodiments, the rim portion 220 can emit a sound, smell, or other signal that may repel bugs or insects or birds or other small animals.

In certain embodiments, a seedling protection system 200 includes a stake or other fastener. In certain embodiments, the stake can partially pass through an eyelet 224 on the seedling protection device 201. In certain embodiments, the seedling protection system 200 includes a receiving component. The receiving component (not illustrated in FIG. 2) may include openings to receive a stake or other fastener (not illustrated in FIG. 2). In certain embodiments, the receiving portion includes a mesh or other material that allows at least some light and water to pass through it. In certain embodiments, the receiving portion can be disposed beneath the plant protection device. The receiving component may also include eyelets 224. In certain embodiments, the stake can penetrate the ground. In certain embodiments, the stake can be received by a receiving component. In certain embodiments, the stake can pass through the eyelets 224 disposed on the seedling protection device 201 and/or the eyelets 224 on the receiving portion. In certain embodiments, the seedling protection device 201 can be secured to the ground using a stake or other fastener.

In use, the user can take the seedling protection device 201 and place it over a seedling or proximal to a seedling. Next, the user can take a stake or other fastener and fasten the seedling protection device 201 to the ground or other surface. This can be accomplished by placing the stake through an eyelet 224 on the seedling protection device 201. Alternatively, the user can place a receiving component proximal to the seedling and place the seedling protection device 201 on a receiving component which serves to lift the seedling protection device 201 off of the ground to accommodate for taller seedlings. The user then places the seedling protection device 201 on top of the receiving component. The stake or other fastener can then be used to fasten the seedling protection device 201 to the receiving component and the receiving component to the ground or other surface.

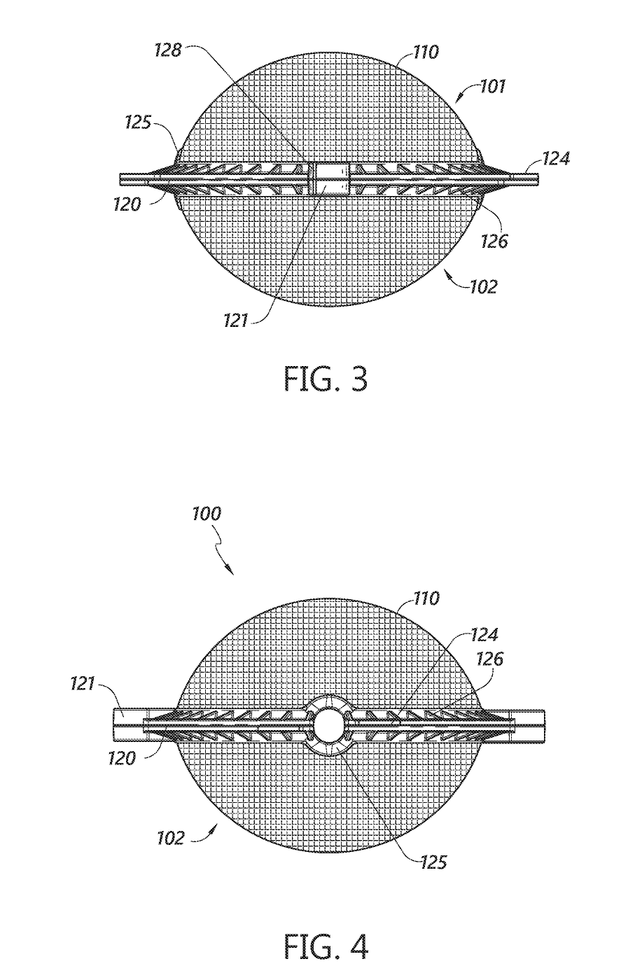

FIG. 3 shows a front-side view of the plant protection 100 device of FIG. 1. FIG. 3 shows an embodiment of a plant protection device 100 including a first and second hemisphere 101, 102 connected to form a substantially spherical plant protection device 100. This view shows an embodiment where the hemispheres 101, 102 are arranged such that the connectors 121 are aligned. The cleft 128 is an indentation on a side of the connector 121 on a first hemisphere that is aligned with a separate cleft 128 a side of the connector 121 on a second hemisphere. These clefts 128 allow for a user to align hemispheres around a fruit by feel and without having to see the alignment of the connectors 121 on upper and lower hemispheres. In certain embodiments where the connectors 121 include a magnet 122 and a disk of ferromagnetic material 123, the first and second hemisphere 101, 102 could be separated by twisting each hemisphere 101, 102 in a different direction or by pulling the hemispheres 101, 102 apart.

FIG. 4 shows a right-side view of the plant protection device 100 of FIG. 1. FIG. 4 shows an embodiment of a plant protection device 100 including a first and second hemisphere 101, 102 connected to form a substantially spherical plant protection device 100. This view shows an embodiment where the hemispheres 101, 102 are arranged such that the connectors 121 are aligned. This view additionally shows an embodiment where the hemispheres 101, 102 are arranged such that the branch openings 125 on each hemisphere 101, 102 are aligned. In certain embodiments, the branch openings 125 on each hemisphere 101, 102 can combine to form one substantially circular, ovular, or elliptical opening. In certain embodiments, the plant protection device 100 includes branch openings 125 on opposite sides of the device 100. In such an embodiment, a straight branch could pass through one side of the plant protection device 100 and out the other side. In some embodiments, a branch will be accommodated by a first side of the plant protection device 100, but not pass through a second side of the plant protection device 100. In such cases, the second side opening may need to accommodate a plug or other barrier to prevent animals or insects or snails, etc. from entering the plant protection device 100. Suitable barriers (not shown) might include a piece of metal, fabric, tape, etc.

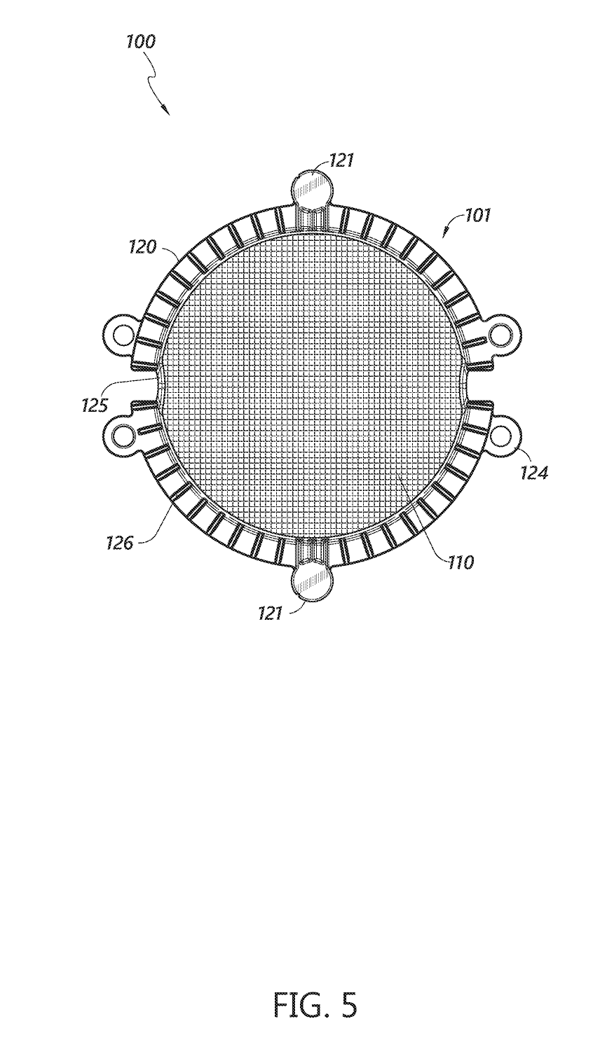

FIG. 5 is a top-down view of the plant protection device 100 of FIG. 1. FIG. 5 shows an embodiment of a plant protection device 100 including a first and second hemisphere 101, 102 connected to form a substantially spherical plant protection device 100. This view shows an embodiment where the hemispheres 101, 102 are arranged such that the connectors 121 and branch openings 125 are aligned. In this embodiment, the eyelets 124 are arranged such that the eyelets 124 of the first hemisphere 101 do not align with the eyelets 124 of the second hemisphere 102 when the connectors 121 are aligned. In certain embodiments, the eyelets 124 are arranged such that the eyelets 124 of the first hemisphere 101 are aligned with the eyelets 124 of the second hemisphere 102 when the connectors 121 are aligned. In certain embodiments where the eyelets 124 are arranged to be aligned when the connectors 121 are aligned, the eyelets 124 can facilitate a more secure connection. The eyelets 124 could, for example, be zip tied or locked to each other to provide a more robust connection than would otherwise be present with magnetic, Velcro, etc. connectors.

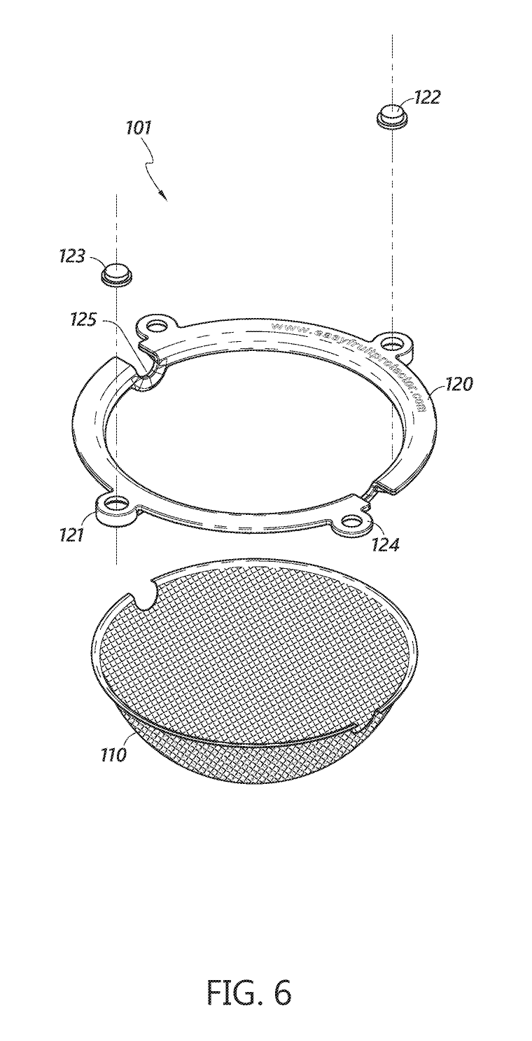

FIG. 6 is an exploded view of one hemisphere of the plant protection device 100 according to one embodiment. In certain embodiments, the plant protection device 100 includes two connectors 121. In certain embodiments having two connectors 121, one connector 121 includes a disk of ferromagnetic material 123 while the other connector 121 includes a magnet 122. The connector 121 including a magnet 122 can further include a second disk of ferromagnetic material, referred to herein as a magnet disk. In certain embodiments, the magnet disk will be attached to one side of the magnet 122. In certain embodiments, a connector 121 may have a receiving opening in which both the magnet disk and magnet 122 can fit into. In certain embodiments, the connector 121 can be formed around the magnet 122 and magnet disk. The connector 121 can surround the magnet disk and/or magnet 122 such that the magnet 122 and/or magnet disk cannot be removed without breaking apart the connector 121. In certain embodiments, the connector 121 is formed around the magnet disk with an opening for the magnet 122 such that the magnet disk cannot be removed without breaking apart the connector 121. In such an embodiment, the magnet 122 can be placed in the opening and may be bonded to the magnet disk. In some embodiments, bonding is not necessary due to magnetic forces between the magnet 122 and the magnet disk. In certain embodiments, a connector 121 is formed at least partially around a disk of ferromagnetic material 123 such that the disk cannot be removed without breaking apart the connector 121. In certain embodiments, the disk of ferromagnetic material 123 can have a lip or a stepped configuration such that there is a flange which is formed within the connector 121 which prevents the disk of ferromagnetic material 123 from being removed without breaking apart the connector 121. In certain embodiments, the connectors 121 will connect to each other due to the magnetic attraction between the magnet 122 and the disk of ferromagnetic material 123. A person of skill in the art will appreciate that the disk of ferromagnetic material 123 and magnet disk can be made out of a variety of ferromagnetic materials including but not limited to steel, cobalt, iron, nickel, lodestone, or some other metal, alloy, or other material. A person of skill in the art will appreciate that the magnet 122 can be made out of a variety of materials including but not limited to Neodymium, samarium-cobalt, Alnico, Ceramic, Ferrite, or some other type of material capable of creating a magnetic attraction to something.

The plant protection device 100 of FIG. 6 can also be a seedling protection device 201. In certain embodiments, a seedling protection device 201 includes all of the same elements of the plant protection device 100 of FIG. 6. In certain embodiments, a seedling protection device 201 will not include a connector 221. In certain embodiments, a seedling protection device 201 will not include a branch opening 225.

In certain embodiments, the seedling protection system 200 and the seedling protection device 201 can be used to protect a variety of plants and their fruits including a variety of apples, tomatoes, grapes, pears, peaches, oranges, bananas, strawberries, blueberries, blackberries, boysenberries, raspberries, other berries, cherries, figs, currants, starfruit, dragon fruit, passion fruit, jackfruit, persimmons, melons, lemons, limes, nectarines, plums, melons, avocados, chili peppers, nuts, herbs, green peppers, red peppers, orange peppers, jalapeno peppers, kale, chard, spinach, okra, flowers, hops, kiwi, mushrooms, and many other types of plants and fungi, and underground vegetables such as beets, carrots, radishes, etc. Additionally, in certain embodiments, the seedling protection system 200 and the seedling protection device 201 can be used to protect all of the aforementioned plants when they are sprouts or seedlings or are at an early stage of their life-cycle. In certain embodiments, the seedling protection system 200 and the seedling protection device 201 can be used to protect a variety of species of trees, shrubberies, bushes, vines, fungi, molds, or other substantially stationary flora.

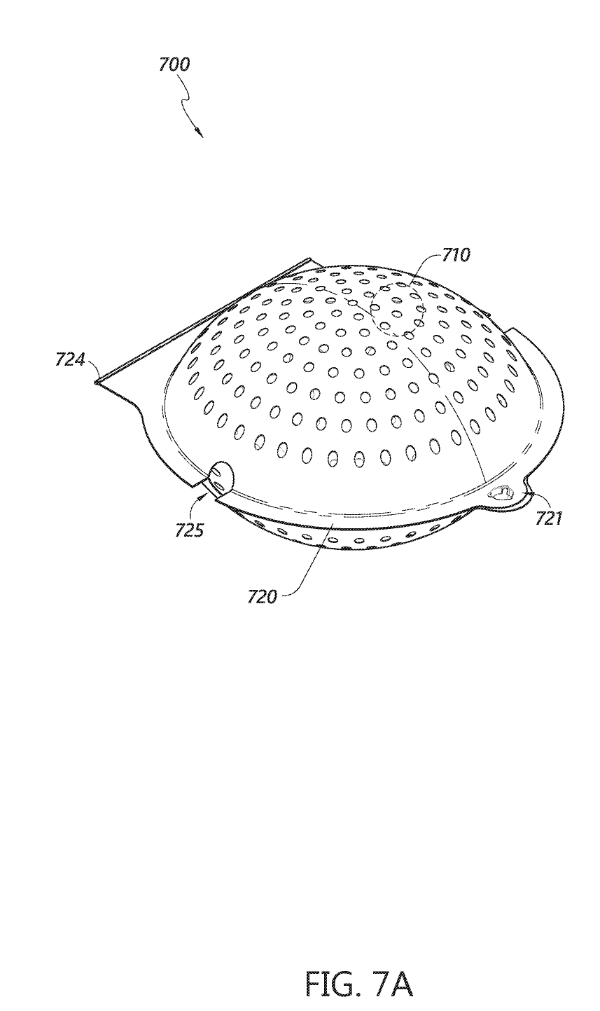

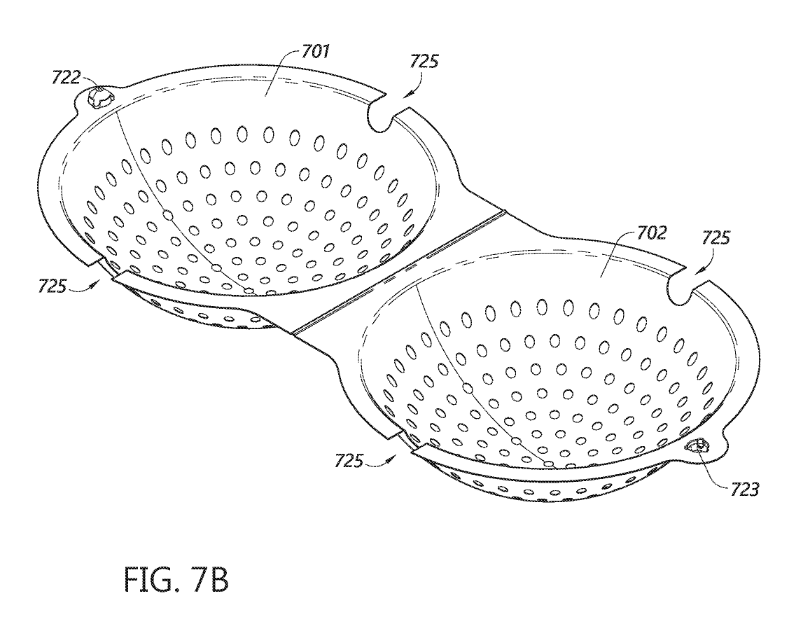

FIGS. 7a and 7b are front perspective views of an embodiment of a plant protection device 700. The plant protection device 700 of FIGS. 7a and 7b includes a first hemisphere 701 and a second hemisphere 702. The first hemisphere 701 and second hemisphere 702 are capable of protecting plants and seedlings from predators or other animals or environmental forces that could damage the plants or seedlings. The first hemisphere 701 and second hemisphere 702 each include a hole pattern 710. The hole pattern 710 can allow plants or seedlings to be exposed to light while providing still providing protection to the plants or seedlings. The hole pattern 710 can provide the plants with light exposure by including several holes arranged across the first hemisphere 701 and second hemisphere 702, with the size and arrangement of the holes allowing the plant protection device 700 not to occlude a substantial portion of sunlight from reaching the plants. A person of skill in the art will appreciate that the hole pattern 710 includes holes with a variety of different shapes, sizes, and patterns. For example, in certain embodiments, the hole pattern 710 includes or consist of holes arranged in a uniform pattern. In some embodiments, the hole pattern 710 includes holes arranged in a swirl pattern. In some embodiments, the hole pattern 710 includes holes arranged in a checkboard pattern. In some embodiments, the hole pattern 710 includes holes arranged in a geometric pattern, including, but not limited to, a linear, circular, triangular, rectangular, hexagonal, or octagonal pattern. In some embodiments, the hole pattern 710 includes holes arranged in a striped pattern. In some embodiments, the hole pattern 710 includes holes arranged in a concentric circular pattern. In some embodiments, the hole pattern 710 includes holes arranged in a chevron pattern. In some embodiments, the hole pattern 710 includes holes arranged in a polka dot pattern. In some embodiments, the hole pattern 710 includes holes arranged in a lattice pattern, a quincunx pattern, a tetractys pattern or a halftone pattern. In certain embodiments, the hole pattern 710 includes or consists of holes of different sizes and shapes. In certain embodiments, the hole pattern 710 includes or consists of holes of the same size and shape. In certain embodiments, one hemisphere 701, 702 includes a hole pattern 710 while another hemisphere 701, 702 does not include a hole pattern 710.

In certain embodiments, the plant protection device 700 includes a rim portion 720. In certain embodiments, the rim portion 720 can be disposed on the edge of the hole pattern 710. In certain embodiments, the rim portion 720 can define the substantially circular boundary that is the edge of a hemisphere 701, 702. The rim portion 720 can be attached to substantially the entire length of the perimeter of the circular boundary that is the edge of a hemisphere 701, 702. In certain embodiments, the rim portion 720 includes a bug or insect repellent. In certain embodiments, the rim portion 720 can emit a sound, smell, or other signal that may repel bugs or insects or birds or other small animals. In certain embodiments, the rim portion 720 of two hemispheres 701, 702 will be connected to each other through a hinge portion 724. In certain embodiments, the rim portion 720 of two hemispheres 701, 702 will be adjacent or proximate to each other when the device 700 is assembled. In certain embodiments, the rim portions 720 of two hemispheres 701, 702 will be substantially in contact with each other when the device 700 is assembled. In certain embodiments, the rim portions 720 will form a substantially sealed interface. In certain embodiments where the rim portions 720 form a substantially sealed interface, the substantially sealed interface can prevent bugs or insects or birds or other small animals from entering the device 700 or prying apart the device 700. In some embodiments, when the device 700 is assembled and the hinge portion 724 is closed, the rim portion 720 of two hemispheres 701, 702, will extend in a direction substantially normal to the surface of the two hemispheres 701, 702 where the two hemispheres 701, 702 are in contact with each other.

In certain embodiments, the plant protection device 700 includes a hinge portion 724. The hinge portion 724 can be connected to the first hemisphere 701 and the second hemisphere 702. In some embodiments, the hinge portion 724 is connected to the rim portion 720. In some embodiments, the hinge portion 724 is connected to both the rim portions 720 and the hemispheres 701,702. In some embodiments, the hinge portion 724 is connected to both the rim portion 720 and the hemispheres 701, 702. In some embodiments, the hinge portion 724 allows a user to easily adjust the location of the hemispheres 701, 702 without dropping or misplacing one of the hemispheres 701, 702. In some embodiments, the hinge portion 724 can adjust the positioning of the hemispheres 701, 702 by having the hemispheres 701, 702 rotate about the hinge portion 724. FIG. 7a illustrates the plant protection device 700 where the hinge portion 724 is in a closed position and FIG. 7b illustrates the plant protection device 700 where the hinge portion 724 is in an opened position. In some embodiments, the hinge portion 724 can be connected to the hemispheres 701, 702, to the rim portion 720, or both, by a fastener, weld, or other mechanical, electrical, or chemical means. In some embodiments, forming the rim portion 720 also forms the hinge portion 724. In some embodiments, the forming process connects the hinge portion 724 to the hemispheres 701, 702, the rim portion 720, or both. In some embodiments, the hinge portion 724 can be removed or detached from the hemispheres 701, 702. In some embodiments, the hinge portion 724 can be removed or detached from the rim portion 720. In some embodiments, the hinge portion 724 can be reattached once removed. In some embodiments, the hinge portion 724 is formed from the same material as the hemispheres 701, 702. In some embodiments, the hinge portion 724 is formed from the same material as the rim portion 720. In some embodiments, the hinge portion 724 contains a groove that allows the hemispheres 701, 702 to rotate easily by reducing the force required to bend the hinge portion 724. In some embodiments, the hinge portion 724 may extend across the entire diameter of the plant protection device 700. In some embodiments, the hinge portion 724 may extend across a section that is less than the entire diameter of the plant protection device 700. In some embodiments, the plant protection device may contain more than one hinge portion 724. In some embodiments, all portions of the plant protection device 700 are formed of a single unified material.

In certain embodiments, the plant protection device 700 includes a connector 721. In certain embodiments, the connector 721 includes a first connector 722 and a second connector 723. In certain embodiments, the first connector 722 includes an extruded shape and the second connector 723 includes a matching indent. The extruded shape can be placed into the indent, creating a friction force that holds the hemispheres 701, 702 together. In certain embodiments, one or more connectors 721 can be disposed on the rim portion 720 of the plant protection device 700. In certain embodiments, the first and second hemispheres 701, 02 each includes two connectors 721. The connectors 721 can be used to create a firm connection between two hemispheres 701, 702 and yet are capable of being disconnected by pulling the hemispheres 701, 702 apart by hand. In certain embodiments where the connectors 721 are attached to the rim portion 720, the connectors 721 can extend out away from the rim portion 720 to a distance of about 0.55 inches. In some embodiments, the distance is between about 0.5 and about 0.6 inches. In certain embodiments, the second hemisphere 702 includes a different number of connectors 721 than the first hemisphere 701. In certain embodiments, the first and second hemispheres 701, 702 each include one or less connectors 721. In certain embodiments, the first and second hemispheres 701, 702 each include more than two connectors 721. In certain embodiments, connectors 721 can be formed, at least partially of, the same material as the rim portion 720. In certain embodiments, at least a portion of the connectors 721 can be formed as part of the same piece of material as the rim portion 720. A person of skill in the art will appreciate that there are many different types of connectors 721 that can be used to join two hemispheres 701, 702 to each other including but not limited to, grommets, Velcro, ties, locking pins, or other types of mechanical, magnetic, or electric fasteners.

In certain embodiments, the plant protection device 700 includes a branch opening 725. The branch opening 725 can allow a branch, vine, or other plant structure to pass through the plant protection device 700. In certain embodiments, the first and/or second hemispheres 701, 702 can each include one or more branch openings 725. Thus, when the first hemisphere 701 and the second hemisphere 702 are in a closed configuration (as shown in FIG. 7a), a branch opening 725 (a first semicircular hole) on the first hemisphere 701 may mate with a branch opening 725 (a second semicircular hole) on the second hemisphere 702 to create a circular branch opening 725 that could substantially include branch or plant structure to pass through. In certain embodiments, the first and/or second hemispheres 701, 702 include two or more branch openings 725 each. In certain embodiments, a branch opening 725 will include a semicircular opening in the rim portion 720 and the hemispheres 701, 702. In certain embodiments, one or more hemispheres 701, 702 may have no branch openings 725. In certain embodiments, one of the hemispheres 701, 702 may have one or more branch openings 725 while the other hemisphere 701, 702 has no branch openings 725. In certain embodiments, the branch openings 725 may each include a full circular opening.

In some embodiments, the plant protection device 700 can be made from a substantially rigid material. The substantially rigid material might include, for example, HDPE or other plastics, steel, aluminum, or other metals, metal alloys, polymers, composite materials, or some combination thereof, or some other material. In certain embodiments, the plant protection device 700 can be made by 3D printing. In some embodiments, the plant protection device 700 can be made by extruding material. In some embodiments, the plant protection device 700 can be made by injection molding. In some embodiments the plant protection device 700 can be made from the same piece of material. In some embodiments, the plant protection device 700 may be made of more than one material. In some embodiments, the rim portion can be made from one material while the hemispheres 701, 702 are made from a separate material. In some embodiments, the first hemisphere 701 can be made from a different material than the second hemisphere 702.

In certain embodiments, the edge of the hemispheres 701, 702 can include a diameter of between 1 and 24 inches, for example, 1, 2, 3, 4, 5, 6, 7, 8, 9, 10, 11, 12, 13, 14, 15, 16, 17, 18, 19, 20, 21, 22, 23, or 24 inches or any value in between. In certain embodiments, the edge of the hole pattern 710 can include a diameter of about 5.5 inches. In certain embodiments, the edge of the hemispheres 701, 702 can have a perimeter of between about 5 inches and 40 inches, for example, 5, 6, 7, 8, 9, 10, 11, 12, 13, 14, 15, 16, 16.5, 17, 17.5, 18, and 18.5, 19, 20, 21, 22, 23, 24, 24, 25, 26, 27, 28, 29, 30, 31, 32, 33, 34, 35, 36, 37, 38, 39, or 40 inches or any value in between. In certain embodiments, the edge of the hemispheres 701, 702 can include a perimeter of about 17.3 inches. In certain embodiments, the edge of the hemispheres 701, 702 can include a height, or distance from the edge to the apex of between 1.0 and 12.0 inches, for example, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3, 4, 5, 6, 7, 8, 9, 10, 11, or 12 inches or any value in between. In certain embodiments, the edge of the hemispheres 701, 702 can include a height, of about 2.1 inches.

In certain embodiments, the rim portion 720 includes an outer diameter of between 5.5 to 7 inches. For example, the outer diameter might be 5, 6, 7, 8, 9, 10, 11, 12, 13, 14, 15, 16, 16.5, 17, 17.5, 18, and 18.5, 19, 20, 21, 22, 23, 24, 24, 25, 26, 27, 28, 29, 30, 31, 32, 33, 34, 35, 36, 37, 38, 39, 40 or 41 inches or any value in between. In certain embodiments, the rim portion 720 includes an outer diameter of about 6.15 inches. In certain embodiments, the rim portion 720 includes an inner diameter of between 5 and 6 inches. For example, the inner diameter might be 5, 6, 7, 8, 9, 10, 11, 12, 13, 14, 15, 16, 16.5, 17, 17.5, 18, and 18.5, 19, 20, 21, 22, 23, 24, 24, 25, 26, 27, 28, 29, 30, 31, 32, 33, 34, 35, 36, 37, 38, 39, or 40 inches or any value in between. In certain embodiments, the rim portion 720 includes an inner diameter of about 5.5 inches.

In certain embodiments, a person can use the plant protection device 700 to protect fruit that is growing on a branch. One can take two hemispheres 701, 702 of a plant protection device 700 and place them together such that they form a substantially spherical plant protection device 700 surrounding the fruit. The hemispheres can be placed together by bending or adjusting the hinge portion 724 so that the hemispheres 701, 702 move towards each other. With the hemispheres 701, 702 close together, a user can press the first connector 722 into the second connector 723 so that the plant protection device 700 can maintain its substantially spherical shape. Further, the branch openings 725 can be aligned such that any branch or vine that the fruit is growing on will pass through branch openings 125. In certain embodiments, the branch openings 725 on one hemisphere 701, 702 will align with the branch openings 725 of the other hemisphere 701, 702 when the first connector 722 is aligned with the second connector 723. Thus, the method for engaging a plant protection device 700 around a piece of fruit on a branch includes the steps of aligning the first connector 722, second connector 723, branch openings 725, and branches/vines in addition to adjusting the hinge portion 724 so that the hemispheres 701, 702 come together with their openings mating against each other or proximal to each other.

The plant protection device 700 can be used to protect a variety of plants and/or their fruits including a variety of apples, tomatoes, grapes, pears, peaches, oranges, bananas, strawberries, blueberries, blackberries, boysenberries, raspberries, other berries, cherries, figs, currants, starfruit, dragon fruit, passion fruit, jackfruit, persimmons, melons, lemons, limes, nectarines, plums, melons, avocados, nuts, chili peppers, green peppers, red peppers, orange peppers, jalapeno peppers, kale, chard, spinach, okra, flowers, hops, kiwi, mushrooms, and many other types of plants and fungi.

Both FIGS. 7a and 7b include contour lines (not numbered) to illustrate the curvature of the outer and inner surfaces of the hemispheres 701, 702.

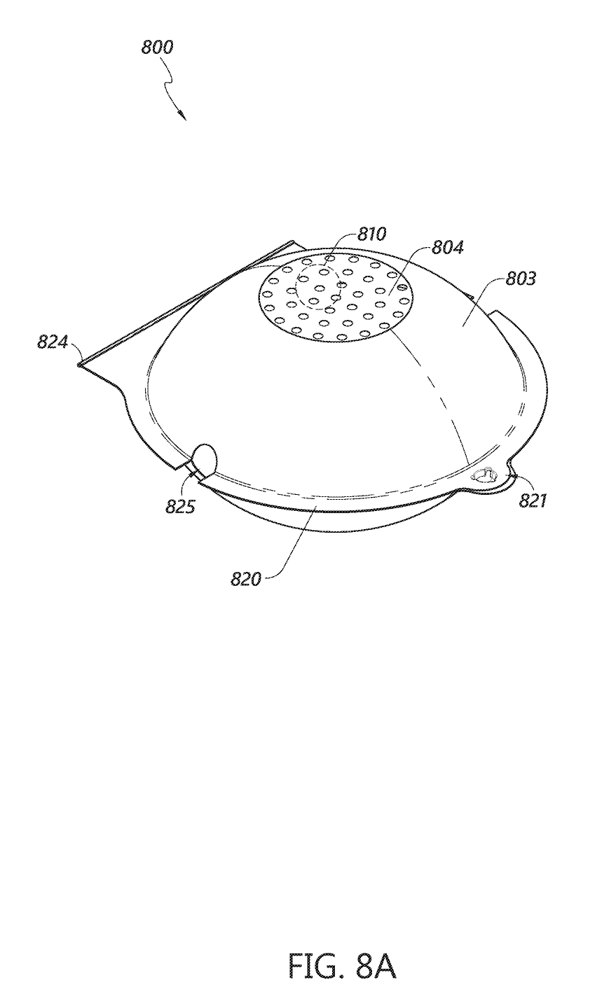

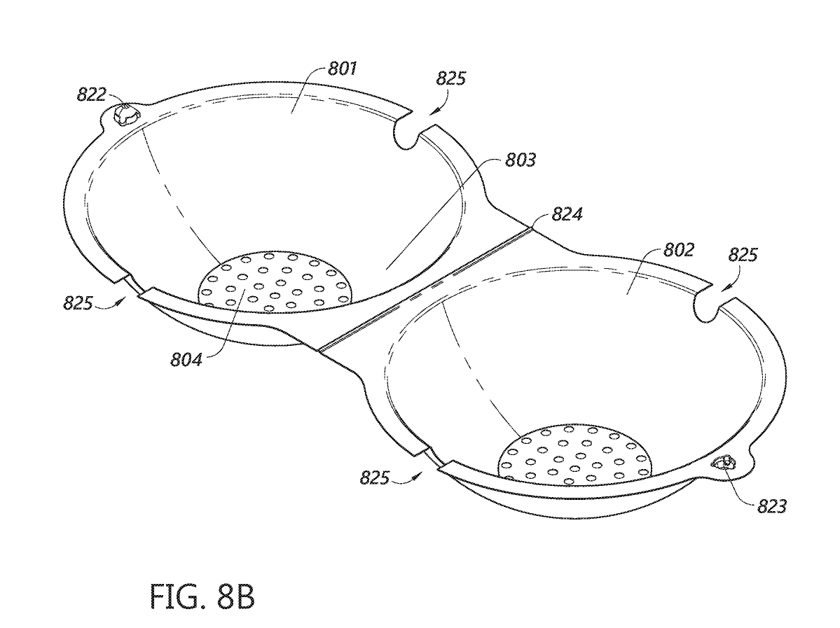

FIGS. 8a and 8b are front perspective views of an embodiment of a plant protection device 800. The plant protection device 800 of FIGS. 8a and 8b include a first hemisphere 801 and a second hemisphere 802. The first hemisphere 801 and second hemisphere 802 are capable of protecting plants and seedlings from predators or other animals or environmental forces that could damage the plants or seedlings. The first hemisphere 801 and second hemisphere 802 include a curved section 803 and a top section 804. The curved section 803 connects the top section 804 to the rim portion 820. In some embodiments, the curved section has a portion of substantially spherical shape. In some embodiments, the top section 804 is a substantially flat or level surface. In some embodiments the top section 804 is curved. In some embodiments, the top section 804 is curved at a different angle than the curved section 803. In some embodiments, the curved section 803 is about the same size as the top section 804. In some embodiments, the curved section 803 is larger than the top section 804. In some embodiments, the top section 804 is larger than the curved section 803. In some embodiments, the top section 804 includes a hole pattern 810. The hole pattern 810 can allow plants or seedlings to be exposed to light while providing still providing protection to the plants or seedlings. The hole pattern 810 can provide the plants with light exposure by including several holes arranged across the top section 804, with the size and arrangement of the holes allowing the plant protection device 800 not to occlude a substantial portion of sunlight from reaching the plants. A person of skill in the art will appreciate that the hole pattern 810 includes holes with a variety of different shapes, sizes, and patterns. For example, in certain embodiments, the hole pattern 810 can include or consist of holes arranged in a uniform pattern. In some embodiments, the hole pattern 810 includes holes arranged in a swirl pattern. In some embodiments, the the hole pattern 810 includes holes arranged in a checkboard pattern. In some embodiments, the hole pattern 810 includes holes arranged in a geometric pattern, including, but not limited to, a linear, circular, triangular, rectangular, hexagonal, or octagonal pattern. In some embodiments, the hole pattern 810 includes holes arranged in a striped pattern. In some embodiments, the hole pattern 810 includes holes arranged in a concentric circular pattern. In some embodiments, the hole pattern 810 includes holes arranged in a chevron pattern. In some embodiments, the hole pattern 810 includes holes arranged in a polka dot pattern. In some embodiments, the hole pattern 810 includes holes arranged in a lattice pattern, a quincunx pattern, a tetractys pattern or a halftone pattern. In certain embodiments, the hole pattern 810 can include or consist of holes of different sizes and shapes. In certain embodiments, the hole pattern 810 can include or consist of holes of the same size and shape. In certain embodiments, one top section 804 can include a hole pattern 810 while another top section 804 does not include a hole pattern 810.

In certain embodiments, the plant protection device 800 can include a rim portion 820. In certain embodiments, the rim portion 820 can be disposed on the edge of the curved section 803. In certain embodiments, the rim portion 820 can define the circular boundary that is the edge of a hemisphere 801, 802. The rim portion 820 can be attached to substantially the entire length of the perimeter of the circular boundary that is the edge of a hemisphere 801, 802. In certain embodiments, the rim portion 820 includes a bug or insect repellent. In certain embodiments, the rim portion 820 can emit a sound, smell, or other signal that may repel bugs or insects or birds or other small animals. In certain embodiments, the rim portion 820 of two hemispheres 801, 802 will be connected to each other through a hinge portion 824. In certain embodiments, the rim portion 820 of two hemispheres 801, 802 will be adjacent or proximate to each other when the device 800 is assembled. In certain embodiments, the rim portions 820 of two hemispheres 801, 802 will be substantially in contact with each other when the device 800 is assembled. In certain embodiments, the rim portions 820 will form a substantially sealed interface. In certain embodiments where the rim portions 820 form a substantially sealed interface, the substantially sealed interface can prevent bugs or insects or birds or other small animals from entering the device 800 or prying apart the device 800.

In certain embodiments, the plant protection device 800 includes a hinge portion 824. The hinge portion 824 can be connected to the first hemisphere 801 and the second hemisphere 802. In some embodiments, the hinge portion 824 is connected to the rim portion 820. In some embodiments, the hinge portion 824 is connected to both the rim portions 820 and the hemispheres 801, 802. In some embodiments, the hinge portion 824 is connected to both the rim portion 820 and the hemispheres 801, 802. In some embodiments, the hinge portion 824 allows a user to easily adjust the location of the hemispheres 801, 802 without dropping or misplacing one of the hemispheres 801, 802. In some embodiments, the hinge portion 824 can adjust the positioning of the hemispheres 801, 802 by having the hemispheres 801, 802 rotate about the hinge portion 824. In some embodiments, the hinge portion 824 can be connected to the hemispheres 801, 802, or to the rim portion 820, by a fastener, weld, or other mechanical, electrical, or chemical means. In some embodiments, forming the rim portion 820 also forms the hinge portion 824. In some embodiments, the forming process connects the hinge portion 824 to the hemispheres 801, 802, the rim portion 820, or both. In some embodiments, the hinge portion 824 can be removed or detached from the hemispheres 801, 802. In some embodiments, the hinge portion 824 can be removed or detached from the rim portion 820. In some embodiments, the hinge portion 824 can be reattached once removed. In some embodiments, the hinge portion 824 is formed from the same material as the hemispheres 801, 802. In some embodiments, the hinge portion 824 is formed from the same material as the rim portion 820. In some embodiments, the hinge portion 824 contains a groove that allows the hemispheres 801, 802 to rotate easily by reducing the force required to bend the hinge portion 824. In some embodiments, the hinge portion 824 may extend across the entire diameter of the plant protection device 800. In some embodiments, the hinge portion 824 may extend across a section that is less than the entire diameter of the plant protection device 800. In some embodiments, the plant protection device may contain more than one hinge portion 824. FIG. 8a illustrates the plant protection device 800 when the hinge portion 824 is in a closed configuration and FIG. 8b illustrates the plant protection device 800 when the hinge portion 824 is in an open configuration. Both FIGS. 8a and 8b include contour lines (not numbered) to illustrate the curvature of outer and inner surfaces of respective portions of the hemispheres 801, 802.

In certain embodiments, the plant protection device 800 includes a connector 821. In certain embodiments, the connector 821 includes a first connector 822 and a second connector 823. In certain embodiments, the first connector 822 includes an extruded shape and the second connector 823 includes a matching indent. The extruded shape can be placed into the indent, creating a friction force that holds the hemispheres 801, 802 together. In certain embodiments, one or more connectors 821 can be disposed on the rim portion 820 of the plant protection device 800. In certain embodiments, the first and second hemispheres 801, 802 each include the connectors 821. The connectors 821 can be used to create a firm connection between two hemispheres 801, 802 and yet the connection is capable of being disconnected by pulling the hemispheres 801, 802 apart by hand. In certain embodiments where the connectors 821 are attached to the rim portion 820, the connectors 821 can extend out away from the rim portion 820 to a distance of about 0.55 inches. In certain embodiments, the second hemisphere 802 includes a different number of connectors 821 than the first hemisphere 801. In certain embodiments, the first and second hemispheres 801, 802 each include one or less connectors 821. In certain embodiments, the first and second hemispheres 801, 802 each comprise more than two connectors 821. In certain embodiments, connectors 821 can be formed, at least partially of, the same material as the rim portion 820. In certain embodiments, at least a portion of the connectors 821 can be formed as part of the same piece of material as the rim portion 820. A person of skill in the art will appreciate that there are many different types of connectors 821 that can be used to join two hemispheres 801, 802 to each other including but not limited to, grommets, Velcro, ties, locking pins, or other types of mechanical, magnetic, or electric fasteners.

In certain embodiments, the plant protection device 800 includes a branch opening 825. The branch opening 825 can allow a branch, vine, or other plant structure to pass through the plant protection device 800. In certain embodiments, the first and/or second hemispheres 801, 802 includes one or more branch openings 825. In certain embodiments, the first and/or second hemispheres 801, 802 include two or more branch openings 825 each. In some embodiments, a semicircular shaped branch opening 825 in the first hemisphere 801 may match with a semicircular branch opening 825 in the second hemisphere 802 when the hinge 824 is in a closed position so that the two semicircular branch openings 825 create a circular shaped branch opening 825 that can permit a branch, vine or other plant structure to pass through the plant protection device 800. In certain embodiments, a branch opening 825 will comprise a semicircular opening in the rim portion 820 and the hemispheres 801, 802. In certain embodiments, one or more hemispheres 801, 802 may have no branch openings 825. In certain embodiments, one of the hemispheres 801, 802 may have one or more branch openings 825 while the other hemisphere 801, 802 has no branch openings 825. In certain embodiments, the branch openings 825 may each comprise a full circular opening.

In some embodiments, the plant protection device 800 can be made from a substantially rigid material. The substantially rigid material might include, for example, HDPE or other plastics, steel, aluminum, or other metals, metal alloys, polymers, composite materials, or some combination thereof, or some other material. In certain embodiments, the plant protection device 800 can be made by 3D printing. In some embodiments, the plant protection device 800 can be made by extruding material. In some embodiments, the plant protection device 800 can be made by injection molding. In some embodiments the plant protection device 800 can be made from the same piece of material. In some embodiments, the plant protection device 800 can be made of more than one material. In some embodiments, the rim portion can be made from one material while the hemispheres 801, 802 are made from a separate material. In some embodiments, the first hemisphere 801 can be made from a different material than the second hemisphere 802. In some embodiments, the curved section 803 can be made a different material than the top section 804. In some embodiments, all portions of the plant protection device 800 are formed of a unitary material.

In certain embodiments, the edge of the hemispheres 801, 802 can comprise a diameter of between 1 and 24 inches, for example, 1, 2, 3, 4, 5, 6, 7, 8, 9, 10, 11, 12, 13, 14, 15, 16, 17, 18, 19, 20, 21, 22, 23, or 24 inches or any value in between. In certain embodiments, the edge of the curved section 803 can comprise a diameter of about 5.5 inches. In certain embodiments, the edge of the hemispheres 801, 802 can have a perimeter of between about 5 inches and 40 inches, for example, 5, 6, 7, 8, 9, 10, 11, 12, 13, 14, 15, 16, 16.5, 17, 17.5, 18, and 18.5, 19, 20, 21, 22, 23, 24, 24, 25, 26, 27, 28, 29, 30, 31, 32, 33, 34, 35, 36, 37, 38, 39, or 40 inches or any value in between. In certain embodiments, the edge of the hemispheres 801, 802 can comprise a perimeter of about 17.3 inches. In certain embodiments, the edge of the hemispheres 801, 802 can comprise a height, or distance from the edge to the apex of between 1.0 and 12.0 inches, for example, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3, 4, 5, 6, 7, 8, 9, 10, 11, or 12 inches or any value in between. In certain embodiments, the edge of the hemispheres 801, 802 can comprise a height, of about 2.1 inches.

In certain embodiments, the rim portion 820 can comprise an outer diameter of between 5.5 to 7 inches. For example, the outer diameter might be 5, 6, 7, 8, 9, 10, 11, 12, 13, 14, 15, 16, 16.5, 17, 17.5, 18, and 18.5, 19, 20, 21, 22, 23, 24, 24, 25, 26, 27, 28, 29, 30, 31, 32, 33, 34, 35, 36, 37, 38, 39, 40 or 41 inches or any value in between. In certain embodiments, the rim portion 820 can comprise an outer diameter of about 6.15 inches. In certain embodiments, the rim portion 820 can comprise an inner diameter of between 5 and 6 inches. For example, the inner diameter might be 5, 6, 7, 8, 9, 10, 11, 12, 13, 14, 15, 16, 16.5, 17, 17.5, 18, and 18.5, 19, 20, 21, 22, 23, 24, 24, 25, 26, 27, 28, 29, 30, 31, 32, 33, 34, 35, 36, 37, 38, 39, or 40 inches or any value in between. In certain embodiments, the rim portion 820 can comprise an inner diameter of about 5.5 inches. In some embodiments, when the hemispheres 801, 802 are in a closed position (as illustrated in FIG. 8a) the rim portion 820 extends substantially normal to the surface where the two hemispheres contact each other.

In certain embodiments, a person can use the plant protection device 800 to protect fruit that is growing on a branch. One can take two hemispheres 801, 802 of a plant protection device 800 and place them together such that they form a substantially spherical plant protection device 800 surrounding the fruit. The hemispheres can be placed together by bending or adjusting the hinge portion 824 so that the hemispheres 801, 802 move towards each other. With the hemispheres 801, 802 close together, a user can press the first connector 822 into the second connector 823 so that the plant protection device 800 can maintain its substantially spherical shape. Further, the branch openings 825 can be aligned such that any branch or vine that the fruit is growing on will pass through branch openings 825. In certain embodiments, the branch openings 825 on one hemisphere 801, 802 will align with the branch openings 825 of the other hemisphere 801, 802 when the first connector 822 is aligned with the second connector 823. Thus, the method for engaging a plant protection device 800 around a piece of fruit on a branch can comprise the steps of aligning the first connector 822, second connector 823, branch openings 825, and branches/vines in addition to adjusting the hinge portion 824 so that the hemispheres 801, 802 come together with their openings mating against each other or proximal to each other.

The plant protection device 800 can be used to protect a variety of plants and/or their fruits including a variety of apples, tomatoes, grapes, pears, peaches, oranges, bananas, strawberries, blueberries, blackberries, boysenberries, raspberries, other berries, cherries, figs, currants, starfruit, dragon fruit, passion fruit, jackfruit, persimmons, melons, lemons, limes, nectarines, plums, melons, avocados, nuts, chili peppers, green peppers, red peppers, orange peppers, jalapeno peppers, kale, chard, spinach, okra, flowers, hops, kiwi, mushrooms, and many other types of plants and fungi.

The foregoing description details some embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

What is claimed is:

1. A plant protection device, comprising:
a first substantially half spherical hemisphere having a first rim portion positioned around a perimeter portion thereof, the first substantially half spherical hemisphere having a substantially hollow interior and two first branch openings substantially opposite each other on the first rim portion;
a second substantially half spherical hemisphere having a second rim portion position around a perimeter portion thereof, the second substantially half spherical hemisphere having a substantially hollow interior;
a first connector on the first rim portion;
a second connector on the second rim portion configured to mate with the first connector;
a hinge portion connecting the first rim portion to the second rim portion, the hinge portion having an open configuration and a closed configuration,
wherein, when the hinge portion is in a closed configuration the first connector contacts the second connector and the first substantially half spherical hemisphere and the second substantially half spherical hemisphere together form a substantially spherical shape.

2. The plant protection device of claim 1, wherein the second substantially half spherical hemisphere comprises two second branch openings positioned substantially opposite each other on the second rim portion.

3. The plant protection device of claim 1, wherein the first substantially half spherical hemisphere includes a plurality of holes extending therethrough.

4. The plant protection device of claim 1, wherein the second substantially half spherical hemisphere includes a plurality of holes extending therethrough.

5. The plant protection device of claim 1, wherein the first substantially half spherical hemisphere has a top section that is substantially flat, the top section including a plurality of holes extending therethrough.

6. The plant protection device of claim 1, wherein the second substantially half spherical hemisphere has a bottom section that is substantially flat, the bottom section including a plurality of holes extending therethrough.

7. A seedling protection device, comprising:
a substantially hemispherical rigid mesh;
a rim portion attached to substantially the entire length of a perimeter of the substantially hemispherical rigid mesh; and
two eyelets attached to the rim portion.
